(19) United States
(12) Patent Application Publication
(10) Pub. No.: US 2022/0405048 A1
(43) Pub. Date: Dec. 22, 2022

(54) DATA PROCESSING APPARATUS, COMPUTER-READABLE RECORDING MEDIUM STORING PROGRAM, AND METHOD OF PROCESSING DATA

(71) Applicant: FUJITSU LIMITED, Kawasaki-shi (JP)

(72) Inventors: Makiko Konoshima, Kawasaki (JP); Hirotaka Tamura, Yokohama (JP)

(73) Assignee: FUJITSU LIMITED, Kawasaki-shi (JP)

(21) Appl. No.: 17/679,154

(22) Filed: Feb. 24, 2022

(30) Foreign Application Priority Data
Jun. 18, 2021 (JP) 2021-101298

(51) Int. Cl. G06F 7/22; G06F 7/544

(52) U.S. Cl. CPC G06F 7/22; G06F 7/5443

(57) ABSTRACT

An apparatus of searching for a combination of values of state variables with which a value of an evaluation function of an Ising-type becomes a local minimum or maximum, the data processing apparatus including: a memory configured to store first local fields representative of first change amounts of the value of the evaluation function in a case where a value of each of the state variables changes, first coefficients indicative of strength of influence of each of the state variables on each of constraint terms representative of a constraint condition, and second local fields represented by a sum of a total sum of products of each of the first coefficients and each of the state variables and a second coefficient related to the constraint condition; and a processor configured to perform: reading any of the first coefficients related to a first state variable being any of the state variables.

### CROSS-REFERENCE TO RELATED APPLICATION

This application is based upon and claims the benefit of priority of the prior Japanese Patent Application No. 2021-101298, filed on Jun. 18, 2021, the entire contents of which are incorporated herein by reference.

### FIELD

The embodiments discussed herein are related to a data processing apparatus, a computer-readable recording medium storing a program, and a method of processing data.

### BACKGROUND

As an apparatus that calculates a large-scale discrete optimization problem which is not easily handled by a Neumann-type computer, there is an Ising machine (also referred to as a Boltzmann machine) using an evaluation function of an Ising type (also referred to as an energy function or the like).

The Ising machine converts a discrete optimization problem into an Ising model representative of a behavior of a spin of a magnetic body. Based on the Markov chain Monte Carlo method such as a simulated annealing method or a replica exchange method (also referred to as, for example, a parallel tempering method), the Ising machine searches for a state of the Ising model that sets a value of the evaluation function of the Ising type (corresponding to energy) to a local minimum. A state having the minimum value out of the local minimums of the evaluation function is an optimal solution. By changing the sign of the evaluation function, the Ising machine is also able to search for a state that sets the value of the evaluation function to a local maximum. The state of the Ising model may be expressed by a combination of values of a plurality of state variables. As the value of each of the state variables, 0 or 1 may be used.

The evaluation function of the Ising type is defined by, for example, a function of a quadratic form such as Expression (1) below.

$$E = - {\sum }_{i = 1}^{N} {\sum }_{j > i}^{N} {W}_{ij} {x}_{i} {x}_{j} - {\sum }_{i = 1}^{N} {b}_{i} {x}_{i} \qquad ( 1 )$$

The first term on the right side is the total of products each obtained from values of two state variables (0 or 1) and a weight value (indicative of the intensity of interaction between the two state variables) in one of all the combinations, without omission and duplication, of N state variables in the Ising model. Here, xᵢ is a state variable with an identification number i, xⱼ is a state variable with an identification number j, and Wᵢⱼ is a weight value indicative of the intensity of interaction between the state variables with the identification numbers i and j. The second term on the right side is the total sum of products each obtained from a bias coefficient and a state variable for one of the identification numbers. Here, bi indicates a bias coefficient for the identification number=i.

An energy change amount (ΔEᵢ) due to a change in the value of xᵢ is represented by Expression (2) below.

$$Δ {E}_{i} = - Δ {x}_{i} ( {\sum }_{j}^{N} {W}_{ij} {x}_{j} + {b}_{i} ) = - Δ {x}_{i} {h}_{i} \qquad ( 2 )$$

In Expression (2), Δxᵢ is −1 when xᵢ changes from 1 to 0, whereas Δxᵢ is 1 when the state variable xᵢ changes from 0 to 1. Here, hᵢ is referred to as a local field and ΔEᵢ is the product of hi and a sign (+1 or −1) depending on Δxᵢ. For this reason, hᵢ may also be referred to as a variable that represents the energy change amount or a variable that determines the energy change amount.

For example, in the case where ΔEᵢ is smaller than a noise value obtained based on a random number and a value of a temperature parameter, a process of updating the value of xᵢ to generate a state transition and also updating the local fields is repeated.

Meanwhile, some discrete optimization problems have a constraint condition to be satisfied by a solution. For example, in a knapsack problem that is one of discrete optimization problems, there is a constraint condition that the total capacity of loads that may be packed in the knapsack is smaller than or equal to the capacity of the knapsack. Such a constraint condition is referred to as an inequality constraint and may be represented by a constraint term having a value other than 0 when the constraint condition is not satisfied.

A total magnitude (energy) of the constraint term of the inequality constraint may be represented by, for example Expression (3) below.

$$V = {\sum }_{j = 1}^{M} ( max [ 0 , {\sum }_{i = 1}^{N} {c}_{ji} {x}_{i} - {u}_{j} ] ) \qquad ( 3 )$$

In Expression (3), M represents the number of constraint terms of the inequality constraint, and cⱼᵢ is a coefficient for each state variable related to each constraint term. An upper limit of a certain resource in the inequality constraint is represented by uⱼ. A function that outputs a larger value of arguments a and b is max [a, b]. For any of j=1 to M, V has a value other than 0 when the total sum of cⱼᵢxᵢ exceeds uᵢ (when the constraint condition is not satisfied).

The entire energy function including the constraint term may be represented as H=E+V.

Expression (3) is a discontinuous function of a linear form unlike a function of a quadratic form such as Expression (1). Accordingly, in the related art, in order to allow an inequality constraint to be handled by the Ising machine, a technique for converting a discontinuous function of a linear form into a function of a quadratic form has been proposed.

However, in the case where a discrete optimization problem is calculated by using a constraint term of an inequality constraint converted into a quadratic form, obtaining a solution by the Ising machine may be difficult due to, for example, an increase in complexity in processing.

Accordingly, a related-art technique has been proposed in which a constraint term of an inequality constraint as described above remaining in the linear form is used and a solution is obtained by the Ising machine.

Examples of the related art include as follows: Japanese Laid-open Patent Publication No. 2019-179364; and Japanese Laid-open Patent Publication No. 2020-204928.

Examples of the related art also include as follows: V. S. Denchev, N. Ding, S. V. N. Vishwanathan, and H. Neven, “Robust classification with adiabatic quantum optimization”, in Proc. ICML'12, pp. 1003-1010, 2012.

### SUMMARY

According to an aspect of the embodiments, there is provided a data processing apparatus of searching for a combination of values of a plurality of state variables with which a value of an evaluation function of an Ising-type becomes a local minimum or a local maximum. In an example, the data processing apparatus includes: a memory configured to store a plurality of first local fields representative of a plurality of first change amounts of the value of the evaluation function in a case where a value of each of the plurality of state variables changes, a plurality of first coefficients indicative of strength of influence of each of the plurality of state variables on each of a plurality of constraint terms representative of a constraint condition, and a plurality of second local fields represented by a sum of a total sum of products of each of the plurality of first coefficients and each of the plurality of state variables and a second coefficient related to the constraint condition; and a processor coupled to the memory, the processor being configured to perform processing including: reading, from the memory, a first coefficient, out of the plurality of first coefficients, related to a first state variable which is any of the plurality of state variables; calculating updated values of the plurality of second local fields in a case where a value of the first state variable changes based on the first coefficient; calculating, in the case where the value of the first state variable changes, a second change amount of a sum of the evaluation function and an entire magnitude of the plurality of constraint terms based on the updated values and a first local field, out of the plurality of first local fields, related to the first state variable; and determining whether to allow a change in the value of the first state variable based on a result of comparison between the second change amount and a predetermined value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a data processing apparatus and a method of processing data according to a first embodiment;

FIG. 2 is a block diagram illustrating a hardware example of a data processing apparatus according to a second embodiment;

FIG. 3 is a block diagram illustrating a functional example of the data processing apparatus;

FIG. 4 is a flowchart illustrating a flow of an example of the method of processing data;

FIG. 5 is a flowchart illustrating a flow of an example of a procedure of an initialization process;

FIG. 6 is a flowchart illustrating a flow of an example of a ΔH calculation procedure;

FIG. 7 illustrates an example of a data processing apparatus according to a third embodiment; and

FIG. 8 illustrates a configuration of an example of a field-programmable gate array (FPGA).

### DESCRIPTION OF EMBODIMENTS

With the related-art technique in which the solution is obtained by using the constraint term of the inequality constraint remaining in the linear form, to calculate the change amount of the entire energy function due to the change in the value of the state variable, the entire magnitude of the constraint term is calculated by using all the coefficients (cᵢⱼ in the example of Expression (3) above) related to each constraint term. In some cases, the number of the coefficients related to each constraint reaches 1000 or more, and a calculation amount may increase with the above-described related-art technique.

In one aspect, an object of the present disclosure is to provide a data processing apparatus, a program, and a method of processing data which may decrease a calculation amount of a discrete optimization problem having a constraint condition.

Hereinafter, the embodiments of the present disclosure will be described with reference to the drawings.

### First Embodiment

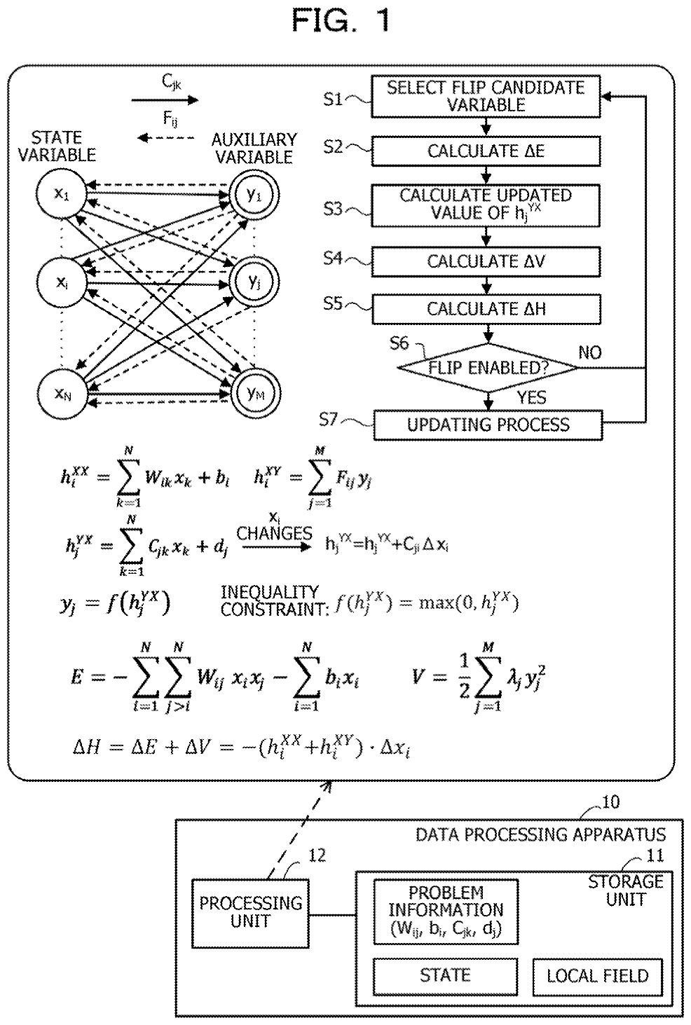

FIG. 1 illustrates an example of a data processing apparatus and a method of processing data according to a first embodiment.

A data processing apparatus 10 according to the first embodiment includes a storage unit 11 and a processing unit 12.

The storage unit 11 is, for example, a volatile storage device including an electronic circuit such as a dynamic random-access memory (DRAM) or a non-volatile storage device including an electronic circuit such as a hard disk drive (HDD) or a flash memory. The storage unit 11 may include an electronic circuit such as a register.

The storage unit 11 stores problem information of a discrete optimization problem, values of a plurality of (hereafter, N) state variables included in an evaluation function of an Ising type representative of the discrete optimization problem (see Expression (1) described above) and values of individual local fields, which will be described later.

The problem information includes, for example, coefficients (cⱼₖ, dⱼ), which will be described later, other than weight values (Wᵢⱼ) and a bias coefficient (bᵢ) indicated in Expression (1).

In FIG. 1, hᵢ^{XX}, hᵢ^{XY}, and hⱼ^{YX} are indicated as the local fields stored in the storage unit 11. Also in FIG. 1, M auxiliary variables (y₁, . . . , yⱼ, . . . , y_{M}) corresponding to the number of constraint terms (M) are represented. Each of y₁ to y_{M} is a variable having 1 bit or a real number able to be calculated from a value of x₁ to x_{N} and represents the constraint term.

The local field hᵢ^{XX} is a local field representative of a change amount of a value of the evaluation function of Expression (1) in the case where a value of a state variable with an identification number=i (i=1 to N) changes, and hᵢ^{XX} corresponds to hᵢ of Expression (2). For example, hᵢ^{XX} may be represented by Expression (4) below.

$${h}_{i}^{XX} = {\sum }_{k = 1}^{N} {W}_{ik} {x}_{k} + {b}_{i} \qquad ( 4 )$$

The local field hⱼ^{YX} may be represented by Expression (5) below.

$${h}_{j}^{YX} = {\sum }_{k = 1}^{N} {C}_{jk} {x}_{k} + {d}_{j} \qquad ( 5 )$$

In Expression (5), Cⱼₖ is a coefficient indicative of the strength of influence of the state variable with the identification number=k on the jth constraint term. For each of the constraint terms, N coefficients Cⱼₖ are provided and represented by a matrix C of M rows by N columns. In Expression (5), dⱼ is the coefficient related to the constraint condition for the jth constraint term.

In the case where the constraint condition is the aforementioned inequality constraint, Cⱼₖ is a cⱼᵢ of Expression (3), and is a value obtained by multiplying uⱼ of Expression (3) by −1.

Furthermore, hᵢ^{XY} may be represented by Expression (6) below.

$${h}_{i}^{XY} = {\sum }_{j = 1}^{M} {F}_{ij} {y}_{j} \qquad ( 6 )$$

In Expression (6), yⱼ is an auxiliary variable representative of the jth constraint term and may be expressed as yⱼ=f(hⱼ^{YX}). For example, in the case where yⱼ is an auxiliary variable related to an inequality constraint, it may be represented as yⱼ=f(hⱼ^{YX})=max[0, hⱼ^{YX}].

The strength of the influence of the jth constraint term on the state variable of xᵢ is indicated by Fᵢⱼ which is a coefficient indicative of the magnitude of a restoring force acting on xᵢ in the case where the constraint condition is not satisfied and which is represented by a matrix F of N rows by M columns. For example, Fᵢⱼ may be represented as Fᵢⱼ=−Cⱼᵢ. For example, the matrix F may be obtained by transposing the matrix C and inverting the sign.

An entire magnitude of M constraint terms (energy) is V which may be represented by Expression (7) below by using yⱼ.

$$V = \frac{1}{2} {\sum }_{j = 1}^{M} {λ}_{j} {y}_{j}^{2} \qquad ( 7 )$$

In Expression (7), λⱼ is a weight for each constraint term and may have different values for different constraint terms.

The storage unit 11 may store various types of data such as calculation conditions used when the processing unit 12 executes the method of processing data, which will be described later (for example, the number of replicas, a value of a temperature parameter set for each of the replicas, a replica exchange cycle, and a calculation end condition in the case where a replica exchange method is executed). In the case where the processing unit 12 executes part or the entirety of processing of the method of processing data, which will be described later, by using software, a program for executing the processing is stored in the storage unit 11.

For example, the processing unit 12 may be realized by using a processor that is hardware such as a central processing unit (CPU), a graphics processing unit, (GPU) or a digital signal processor (DSP). Instead, the processing unit 12 may be realized by using an electronic circuit such as an application-specific integrated circuit (ASIC) or a field-programmable gate array (FPGA).

For example, the processing unit 12 searches for a state in which the value of the evaluation function (energy) represented by Expression (1) becomes a local minimum. The optimal solution is a state having the minimum value among local minimums of the evaluation function. By changing the signs of the constraint terms indicated in Expression (7) and the evaluation function represented by Expression (1), the processing unit 12 may search for a state in which the value of the evaluation function becomes the local maximum (in this case, a state having the maximum value is the optimal solution).

FIG. 1 illustrates a flow of an example of part of processing performed by the processing unit 12.

Here, it is assumed that values based on the initial values of x₁ to x_{N} are stored in the storage unit 11 as hᵢ^{XX}, hᵢ^{XY}, hⱼ^{YX}, yⱼ, E, and V.

The processing unit 12 selects, out of x₁ to x_{N}, a candidate state variable the value of which is to be changed (hereafter referred to as a flip candidate) (step S1). For example, the processing unit 12 selects a flip candidate state variable randomly or in a predetermined order.

The processing unit 12 calculates a change amount of the value of the evaluation function (ΔE) in the case where the value of the selected state variable changes (step S2). In the case where the selected state variable is xᵢ, ΔE may be calculated by using a product of −Δxᵢ and hᵢ^{XX}.

In order to calculate a change amount of V due to the change in the value of a selected state variable (ΔV), the processing unit 12 uses a coefficient related to the selected state variable out of Cⱼₖ to calculate updated values of M local fields hⱼ^{YX} due to the change in the value of the state variable (step S3). The processing of step S3 corresponds to reflecting the influence of the change in the value of the selected state variable on the constraint term. In the case where the selected state variable is xᵢ, the processing unit 12 may calculate the updated values of hⱼ^{YX} by adding CⱼᵢΔxᵢ to the original hⱼ^{YX}. Thus, it is sufficient that the processing unit 12 read the coefficients in an i column in the matrix C of M×N.

Based on the updated values of the M local fields hⱼ^{YX}, the processing unit 12 calculates ΔV (step S4). Based on the updated values of hⱼ^{YX}, the processing unit 12 may calculate yⱼ, calculate V after the change in the value of the flip candidate state variable from Expression (7), and calculate ΔV by using the difference from original V. The processing unit 12 may also calculate hᵢ^{XY} by using Expression (6) by using yⱼ calculated based on the updated values of hⱼ^{YX} and may calculate ΔV by using the products of −Δxᵢ and hᵢ^{XY}.

By using the sum of ΔE and ΔV, the processing unit 12 calculates ΔH (step S5).

Based on a result of comparison between ΔH and a predetermined value, the processing unit 12 determines whether to allow the change in the value of the flip candidate state variable (whether to enable or disable the flipping) (step S6). Hereinafter, this determination process is referred to as a flip determination process.

The predetermined value is, for example, a noise value obtained based on a random number and the value of the temperature parameter. The processing unit 12 determines that the change in the value of the flip candidate state variable is allowed in the case where, for example, ΔH is smaller than log (rand)×T which is an example of the noise value obtained based on a uniform random number (rand) of greater than or equal to 0 and smaller than or equal to 1 and the temperature parameter (T).

The processing unit 12 performs processing in step S7 in the case where it is determined that the flipping is enabled or repeats the processing from step S1 in the case where it is determined that the flipping is not enabled.

In the processing of step S7, the processing unit 12 updates the state stored in the storage unit 11 by changing the value of the selected state variable and also updates hᵢ^{XX}, hᵢ^{XY}, and hⱼ^{YX} due to the change.

For example, updating of hⱼ^{YX} due to a change in a value of xₐ may be performed by using the following expression: hᵢ^{XX}=hᵢ^{XX}+WᵢₐΔxₐ. For example, it is sufficient that the processing unit 12 read weight values in an a column in a matrix of N×N weight values.

Updating of hⱼ^{YX} is performed by determining the updated values calculated in the processing in step S3.

Furthermore, updating of hᵢ^{XY} may be performed by calculating yⱼ after the updating based on the updated values of hⱼ^{YX} calculated in the processing of step S3 and using a difference (Δyⱼ) from yⱼ before the updating by using the following expression: hᵢ^{XY}=hᵢ^{XY}+FᵢⱼΔyⱼ. As described above, since Fᵢⱼ=−Cⱼᵢ, Fᵢⱼ may be calculated by using the coefficients in the i column of the matrix C read in the processing of step S3.

The processing unit 12 repeatedly performs the processing from steps S1 to S7 until a predetermined end condition is satisfied.

The order of the above-described processes is merely exemplary and may be changed as appropriate.

Although an example in which the processing of steps S2 to S6 is performed by selecting the flip candidate state variables one by one out of N state variables has been described in the above description, the processing of steps S2 to S6 may be performed in parallel for a plurality of (for example, all of N) state variables. In this case, when there are a plurality of state variables the values of which are allowed to be changed, the processing unit 12 selects the state variables the values of which are to be changed randomly or in accordance with a predetermined rule.

In the case of performing a simulated annealing method, the processing unit 12 decreases the value of the above-described temperature parameter (T) according to a predetermined temperature parameter change schedule every time, for example, the flip determination process is repeatedly performed a predetermined number of times. The processing unit 12 outputs the state obtained in the case where the flip determination process has been repeatedly performed the predetermined number of times as a calculation result of the discrete optimization problem (for example, displays on a display device not illustrated). The processing unit 12 may update the value of the evaluation function (energy) represented by Expression (1) every time the change in the value of the state variable is generated and cause the storage unit 11 to hold the energy and the state in the case where the energy becomes the minimum energy up to that time. In this case, the processing unit 12 may output, as the calculation result, the state corresponding to the minimum energy stored after the flip determination process has been repeatedly performed the predetermined number of times.

In the case where the processing unit 12 performs the replica exchange method, the processing unit 12 performs the processing of steps S1 to S3 described above in a plurality of different replicas in which different values of the temperature parameter are set. Every time the flip determination process is repeatedly performed a predetermined number of times, the processing unit 12 performs a replica exchange. For example, the processing unit 12 randomly selects two replicas out of the plurality of replicas and exchanges the value of the temperature parameter or the state between the two selected replicas with a predetermined exchange probability based on an energy difference between the replicas and the difference in the value of the temperature parameter between the replicas. For example, the processing unit 12 updates the value of the evaluation function (energy) represented by Expression (1) every time the change in the value of the state variable is generated in each of the replicas and holds the energy and the state in the case where the energy becomes the minimum energy up to that time. The processing unit 12 outputs, as the calculation result, the state corresponding to the minimum energy in all the replicas out of the minimum energies stored after the above-described flip determination process has been repeatedly performed the predetermined number of times in each of the replicas.

With the data processing apparatus 10 and the method of processing data as described above, ΔH used when determining whether to enable or disable the change in the value of the state variable is calculated based on hᵢ^{XX} and hⱼ^{YX} or hᵢ^{XY} calculated from hⱼ^{YX} by using Expression (6)). Based on the result of the comparison between ΔH and the predetermined value, whether to allow the change in the value of the state variable is determined. As described above, in the calculation of the updated values of hⱼ^{YX} for calculating ΔH, it is sufficient that the coefficients in a certain column of the matrix C be read.

Thus, the amount of calculation may be decreased compared to the case where the flip determination for a certain state variable is performed by using all the elements of the matrix C. Furthermore, the amount of data read at a time from the storage unit 11 may be decreased.

Since yⱼ which is the auxiliary variable and hᵢ^{XX}, hᵢ^{XY}, and hⱼ^{YX} which are the local fields are obtained from the values of the state variables or the like, none of yⱼ, hᵢ^{XX}, hᵢ^{XY}, and hⱼ^{YX} is an independent variable and increases a searching space.

A constraint condition applicable in the method of processing data according to the first embodiment is not limited to the inequality constraint. An equality constraint or an absolute value constraint may be applicable.

The equality constraint is a constraint that sets a value equivalent to a resource instead of setting an upper limit of a certain resource as in the inequality constraint.

A constraint term of the equality constraint may be represented by, for example, Expression (8) below.

$$V = {\sum }_{j = 1}^{M} {( {\sum }_{i = 1}^{N} {c}_{ji} {x}_{i} - {u}_{j} )}^{2} \qquad ( 8 )$$

In Expression (8), for any of j=1 to M, V has a value other than 0 in the case where the total sum of cⱼᵢxᵢ is a value different from the uⱼ representing the resource (in the case where the constraint condition is not satisfied).

The absolute value constraint is a constraint in which the value of V which is a constraint term increases as the absolute value of the difference from a certain resource increases. A constraint term of the absolute value constraint may be represented by, for example, Expression (9) below.

$$V = {\sum }_{j = 1}^{M} abs ( {\sum }_{i = 1}^{N} {c}_{ji} {x}_{i} - {u}_{j} ) \qquad ( 9 )$$

In Expression (9), abs is a function that outputs an absolute value of an argument. For example, V is the sum of the absolute values of differences between the total sum of cⱼᵢxᵢ and uⱼ which is the resource for each of j=1 to M. The constraint term of the absolute value constraint may also be represented by combining two constraint terms of the inequality constraint illustrated in Expression (3).

In the case where the equality constraint or the absolute value constraint as described above is applied, it is sufficient that Cⱼₖ of Expression (5) be set as cⱼᵢ of Expression (8) or Expression (9) and of Expression (5) be set as a value obtained by multiplying uⱼ of Expression (3) by −1. As yⱼ of Expression (6), in the case where yⱼ is an auxiliary variable related to the equality constraint, yⱼ may be represented as yⱼ=f(hⱼ^{YX})=(hⱼ^{YX})². As hⱼ of Expression (6), in the case where yⱼ is an auxiliary variable related to the absolute value constraint, yⱼ may be represented as yⱼ=f(hⱼ^{YX})=abs(hⱼ^{YX}).

Accordingly, also in the case where these constraint conditions are used, substantially the same processing as that performed in the case where the inequality constraint is used may be applied other than the change in the function of f(hⱼ^{YX}).

### Second Embodiment

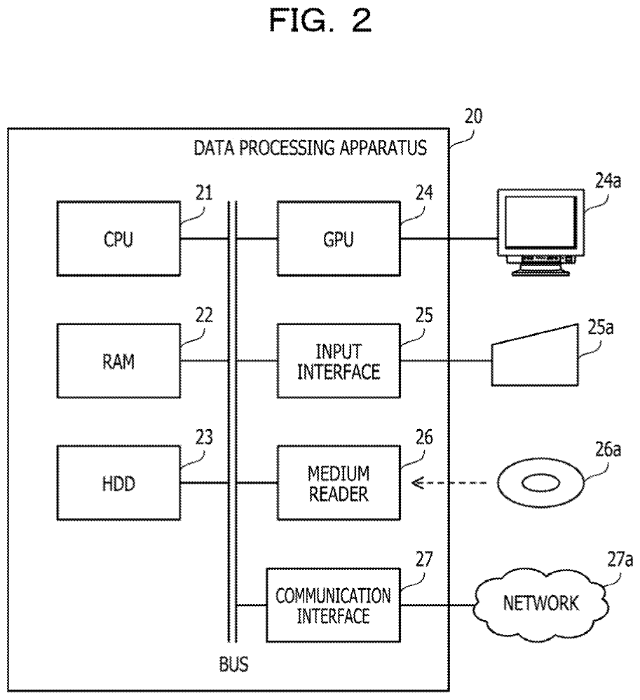

FIG. 2 is a block diagram illustrating a hardware example of a data processing apparatus according to a second embodiment.

A data processing apparatus 20 is, for example, a computer and includes a CPU 21, a random-access memory (RAM) 22, an HDD 23, a GPU 24, an input interface 25, a medium reader 26, and a communication interface 27. The above-described devices are coupled to a bus.

The CPU 21 is a processor including an arithmetic circuit that executes program instructions. The CPU 21 loads at least a subset of programs and data stored in the HDD 23 into the RAM 22 and executes the programs. The CPU 21 may include a plurality of processor cores, or the data processing apparatus 20 may include a plurality of processors. Processes to be described below may be executed in parallel by using the plurality of processors or processor cores. A set of a plurality of processors (multiprocessor) may be referred to as a “processor”.

The RAM 22 is a volatile semiconductor memory that temporarily stores the programs executed by the CPU 21 or the data used for the arithmetic by the CPU 21. The data processing apparatus 20 may include a memory of a type other than the type of the RAM 22 and may include a plurality of memories.

The HDD 23 is a non-volatile storage device that stores the programs of software such as an operating system (OS), middleware, and application software, and data. Examples of the programs include a program for causing the data processing apparatus 20 to execute a process of searching for a solution to a discrete optimization problem. The data processing apparatus 20 may include another type of the storage device such as a flash memory or a solid-state drive (SSD) and may include a plurality of non-volatile storage devices.

The GPU 24 outputs images to a display 24a coupled to the data processing apparatus 20 in accordance with instructions from the CPU 21. As the display 24a, a cathode ray tube (CRT) display, a liquid crystal display (LCD), a plasma display panel (PDP), an organic electro-luminescence (OEL) display, or the like may be used.

The input interface 25 obtains an input signal from an input device 25a coupled to the data processing apparatus 20 and outputs the input signal to the CPU 21. As the input device 25a, a pointing device such as a mouse, a touch panel, a touchpad, and a trackball, as well as a keyboard, a remote controller, a button switch, or the like may be used. A plurality of types of input devices may be coupled to the data processing apparatus 20.

The medium reader 26 is a reading device that reads programs and data recorded in a recording medium 26a. As the recording medium 26a, for example, a magnetic disk, an optical disk, a magneto-optical (MO) disk, a semiconductor memory, or the like may be used. Examples of the magnetic disk include a flexible disk (FD) and an HDD. Examples of the optical disk include a compact disc (CD) and a Digital Versatile Disc (DVD).

For example, the medium reader 26 copies the programs or the data read from the recording medium 26a to another recording medium such as the RAM 22 or the HDD 23. For example, the read programs are executed by the CPU 21. The recording medium 26a may be a portable-type recording medium and, in some cases, is used to distribute the programs and the data. The recording medium 26a and the HDD 23 may be referred to as computer-readable recording media.

The communication interface 27 is an interface that is coupled to a network 27a and that communicates with another information processing apparatus via the network 27a. The communication interface 27 may be a wired communication interface coupled to a communication device such as a switch via a cable or a wireless communication interface coupled to a base station via a wireless link.

Next, the functions and a processing procedure of the data processing apparatus 20 are described.

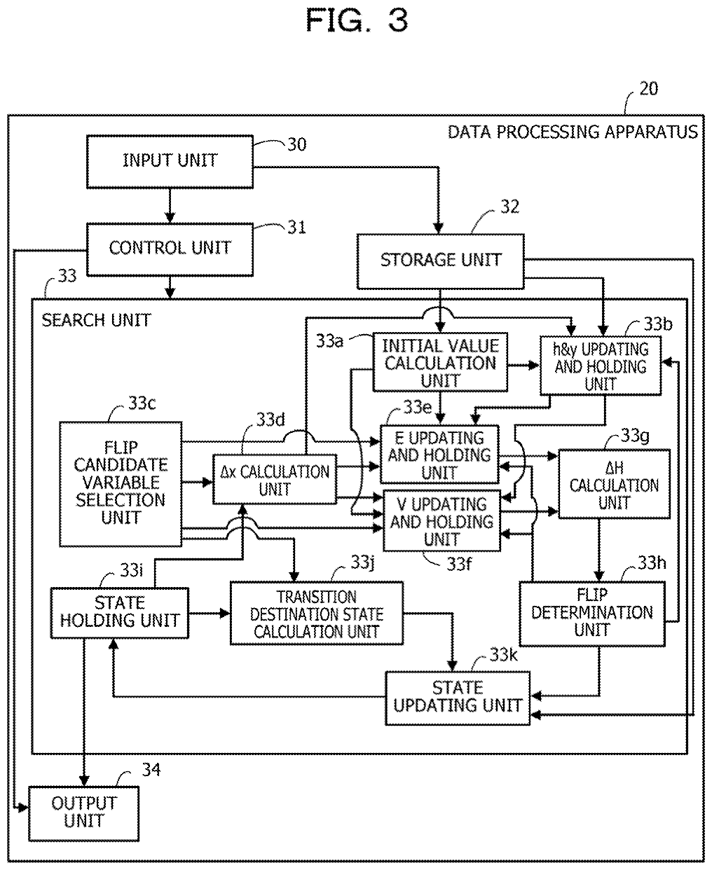

FIG. 3 is a block diagram illustrating a functional example of the data processing apparatus.

The data processing apparatus 20 includes an input unit 30, a control unit 31, a storage unit 32, a search unit 33, and an output unit 34.

The input unit 30, the control unit 31, the search unit 33, and the output unit 34 may be implemented by using, for example, program modules executed by the CPU 21 or a storage area (a register or a cache memory) in the CPU 21. The storage unit 32 may be implemented by using, for example, a storage area reserved in the RAM 22 or the HDD 23.

The input unit 30 accepts, for example, input of initial values of the state variables (x₁ to x_{N}), the problem information, and calculation conditions. The problem information includes, for example, the coefficients (Cⱼₖ, dⱼ) indicated in Expression (5), the coefficient (Fᵢⱼ) indicated in Expression (6), and the weight (λⱼ) for each constraint indicated in Expression (7) in addition to the weight value (Wᵢⱼ) and the bias coefficient (bᵢ) indicated in Expression (1). Examples of the calculation conditions include, for example, the number of replicas, the replica exchange cycle, the value of the temperature parameter set for each of the replicas in the case where the replica exchange method is executed, and the temperature parameter change schedule, the calculation end condition, and so forth in the case where the simulated annealing method is performed.

These pieces of information may be input by a user operating the input device 25a or input via the recording medium 26a or the network 27a.

The control unit 31 controls the units in the data processing apparatus 20 to cause the units to execute processing to be described later.

The storage unit 32 stores the initial values of x₁ to X_{N}, Wᵢⱼ, bᵢ, Cⱼₖ, dⱼ, Fᵢⱼ, and λⱼ. The storage unit 32 may store various types of information such as the other pieces of the problem information and the other calculation conditions.

The search unit 33 includes an initial value calculation unit 33a, an h&y updating and holding unit 33b, a flip candidate variable selection unit 33c, a Δx calculation unit 33d, an E updating and holding unit 33e, and a V updating and holding unit 33f. The search unit 33 further includes a ΔH calculation unit 33g, a flip determination unit 33h, a state holding unit 33i, a transition destination state calculation unit 33j, and a state updating unit 33k.

The initial value calculation unit 33a reads the initial values of x₁ to x_{N}, bᵢ, Cⱼₖ, and dⱼ stored in the storage unit 32 and, based on these values, calculates the initial values of hⱼ^{YX} and hⱼ^{YX} by using Expressions (4) and (5). Also, the initial value calculation unit 33a calculates the initial value of yⱼ from the initial value of hⱼ^{YX} by using the following expression: yⱼ=f(hⱼ^{YX}).

In the case where yⱼ is an auxiliary variable related to the inequality constraint, it may be represented as yⱼ=f(hⱼ^{YX})=max[0, hⱼ^{YX}] as described above. In the case where yⱼ is an auxiliary variable related to the equality constraint, it may be represented as yⱼ=f(hⱼ^{YX})=(hⱼ^{YX})² as described above. In the case where y, is an auxiliary variable related to the absolute value constraint, it may be represented as yⱼ=f(hⱼ^{YX})=abs(hⱼ^{YX}) as described above.

Furthermore, the initial value calculation unit 33a reads Fᵢⱼ stored in the storage unit 32 and calculates, based on the calculated initial value of yⱼ and Fᵢⱼ, the initial value of hᵢ^{XY} by using Expression (6).

The h&y updating and holding unit 33b updates hᵢ^{XX}, hⱼ^{YX}, hᵢ^{XY}, and yⱼ and holds values of these.

The updated value of hⱼ^{YX} due to the change in the value of xₐ may be represented by the following expression: hᵢ^{XX}=hⱼ^{YX}+WᵢₐΔxₐ. The updated value of hⱼ^{YX} due to the change in the value of xₐ may be represented by the following expression: hⱼ^{YX}=hⱼ^{YX}+CⱼₐΔxₐ. The updated value of hᵢ^{XY} due to the change in the value of xₐ may be represented by the following expression: hᵢ^{XY}=hᵢ^{XY}+FᵢⱼΔyⱼ. Calculation of Δyⱼ is performed by using an expression Δyⱼ=f(hⱼ^{YX})−yⱼ using the updated value of hⱼ^{YX}.

The flip candidate variable selection unit 33c selects a flip candidate state variable. For example, the flip candidate variable selection unit 33c selects a flip candidate state variable randomly or in a predetermined order. The flip candidate variable selection unit 33c outputs an identification number (1 to N) of the selected flip candidate state variable.

The Δx calculation unit 33d calculates the change amount of the value of the selected flip candidate state variable. For example, when the flip candidate state variable is xₐ, Δxₐ becomes −1 in the case where xₐ changes from 1 to 0, and Δxₐ becomes 1 in the case where the state variable xₐ changes from 0 to 1.

The E updating and holding unit 33e updates E which is the value of the evaluation function represented by Expression (1), and the E updating and holding unit 33e holds E. The change amount of E due to a change in the value of xₐ is ΔE which may be expressed as ΔE=−Δxₐhₐ^{XX}. Accordingly, in the case where the value of xₐ changes, E is updated to E=E−Δxₐhₐ^{XX}.

The V updating and holding unit 33f updates V which is the entire size of the M constraint terms indicated in Expression (7), and the V updating and holding unit 33f holds V. In order to calculate ΔV which is the change amount of V due to the change in the value of xₐ, the V updating and holding unit 33f calculates the updated values of M local fields hⱼ^{YX} due to the change in xₐ by using the following expression: hⱼ^{YX}=hⱼ^{YX}+CⱼₐΔxₐ. Based on the updated values of M local fields hⱼ^{YX}, the V updating and holding unit 33f may calculate M auxiliary variables yⱼ, calculate V after the change in the value of the flip candidate state variable from Expression (7), and calculate ΔV by using the difference from original V. The V updating and holding unit 33f may also calculate hₐ^{XY} by using Expression (6) by using yⱼ calculated based on the updated values of hⱼ^{YX} and may calculate ΔV by using the product of −Δxₐ and hₐ^{XY}.

The ΔH calculation unit 33g calculates ΔH by adding ΔE and ΔV obtained when E is updated and V is updated by the E updating and holding unit 33e and the V updating and holding unit 33f.

Based on the result of the comparison between ΔH and the predetermined value, the flip determination unit 33h performs the flip determination process that determines whether to allow the change in the value of the flip candidate state variable. The predetermined value is, for example, a noise value obtained based on a random number and the value of the temperature parameter. The flip determination unit 33h determines that the change in the value of the flip candidate state variable is allowed in the case where, for example, ΔH is smaller than log (rand)×T which is an example of the noise value obtained based on a uniform random number (rand) greater than or equal to 0 and smaller than or equal to 1 and the temperature parameter (T).

The state holding unit 33i holds the values of N state variables (x₁ to x_{N}).

The transition destination state calculation unit 33j calculates a transition destination state in which the value of the state variable of the identification number output by the flip candidate variable selection unit 33c out of x₁ to x_{N} is changed.

In the case where the flip determination unit 33h determines that the change in the value of the state variable is allowed, the state updating unit 33k uses the transition destination state calculated by the transition destination state calculation unit 33j to update the state held by the state holding unit 33i.

Under the control of the control unit 31, the search unit 33 searches for a state in which the value of the evaluation function (energy) becomes the local minimum by repeatedly performing the flip determination process and the updating process of each parameter as described above.

The output unit 34 outputs a search result (calculation result) of the search unit 33. For example, in the case where the replica exchange method is performed, the output unit 34 outputs, as the calculation result, the state corresponding to the minimum energy in all the replicas out of the minimum energies stored after the above-described flip determination process has been repeatedly performed the predetermined number of times in each of the replicas.

For example, the output unit 34 may output and display the calculation result on the display 24a, transmit the calculation result to another information processing apparatus via the network 27a, or store the calculation result in an external storage device.

Hereinafter, the processing procedure (a method of processing data) of the data processing apparatus 20 will be described. An example in which search is performed by using the replica exchange method is described below.

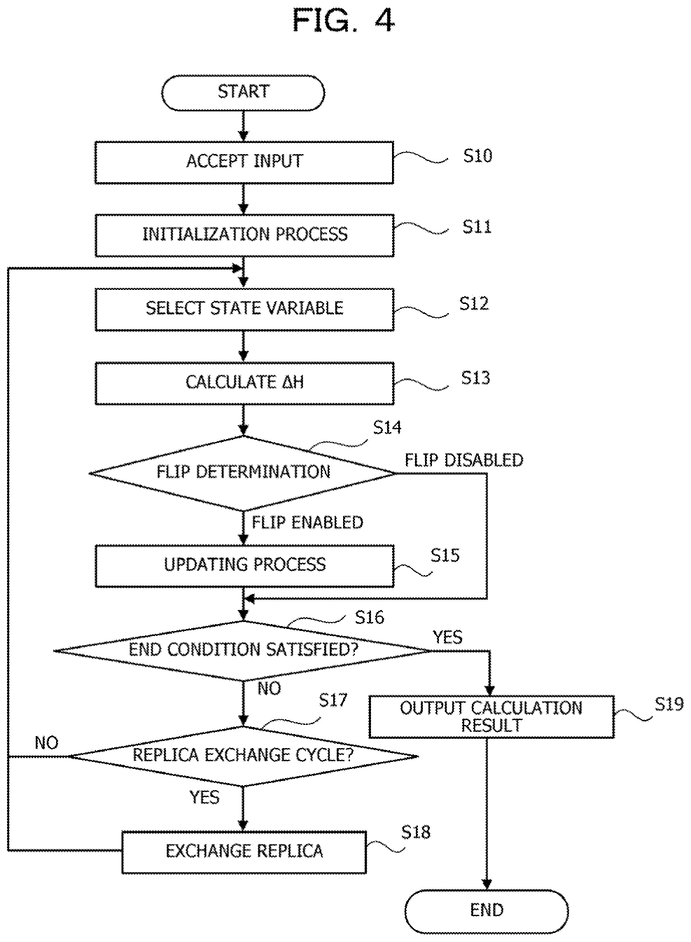

FIG. 4 is a flowchart illustrating a flow of an example of the method of processing data.

Step S10: The input unit 30 accepts input of the initial values of x₁ to x_{N}, the above-described problem information, and the calculation conditions. For example, the initial values of x₁ to x_{N} and the problem information having been input are stored in the storage unit 32, and the calculation conditions having been input are supplied to the control unit 31.

Step S11: The initialization process is performed for each of the replicas. An example of a procedure of the initialization process will be described later.

For each of the replicas, the control unit 31 causes the search unit 33 to perform processing of steps S12 to S16 below.

Step S12: The flip candidate variable selection unit 33c of the search unit 33 selects a candidate state variable the value of which is to be changed (updated).

STEP S13: A search unit 33 calculates ΔH. An example of a calculation procedure of ΔH of step S13 will be described later.

Step S14: The flip determination unit 33h performs the flip determination based on the result of the comparison between ΔH and a predetermined value. In the case where the flip determination unit 33h determines that the change in the value of the state variable is allowed, (in the case of “FLIP ENABLED”), processing of step S15 is performed. In the case where the flip determination unit 33h determines that the change in the value of the state variable is not allowed (in the case of “FLIP DISABLED”), processing of step S16 is performed.

Step S15: The updating process is performed. In the processing of step S15, the state is updated by the state updating unit 33k, hᵢ^{XX}, hⱼ^{YX}, hᵢ^{XY}, and yⱼ are updated by the h&y updating and holding unit 33b, and E and V are updated by the E updating and holding unit 33e and the V updating and holding unit 33f.

Step S16: The control unit 31 determines whether the processing satisfies a predetermined end condition. For example, in the case where the number of times the search unit 33 performs the flip determination process has reached a maximum number of times of the flip determination, the control unit 31 determines that the end condition is satisfied. In the case where it is determined that the processing satisfies the predetermined end condition, processing of step S19 is performed. In the case where it is determined that the processing does not satisfy the predetermined end condition, processing of step S17 is performed.

Step S17: The control unit 31 determines whether the number of times of the flip determination indicates the replica exchange cycle. For example, in the case where a remainder of the number of times of the flip determination divided by a value indicative of the replica exchange cycle is 0, the control unit 31 determines that the number of times of the flip determination indicates the replica exchange cycle.

The control unit 31 performs processing of step S18 in the case where it is determined that the number of times of the flip determination indicates the replica exchange cycle. The control unit 31 causes the search unit 33 to repeat the processing from step S12 in the case where it is determined that the number of times of the flip determination does not indicate the replica exchange cycle.

Step S18: The control unit 31 performs a replica exchange process. For example, the control unit 31 randomly selects two replicas out of the plurality of replicas and exchanges the value of the set temperature parameter or the state between the two selected replicas with a predetermined exchange probability based on an energy difference between the replicas and the difference in the value of the temperature parameter between the replicas. After the processing of step S18, the control unit 31 causes the search unit 33 to repeat the processing from step S12.

Step S19: The output unit 34 outputs the calculation result. For example, the output unit 34 outputs, as the calculation result, the state corresponding to the minimum energy in all the replicas out of the minimum energies stored in each of the replicas. For example, the output unit 34 may output and display the calculation result on the display 24a, transmit the calculation result to another information processing apparatus via the network 27a, or store the calculation result in an external storage device.

Next, an example of the procedure of the initialization process of step S11 described above is described.

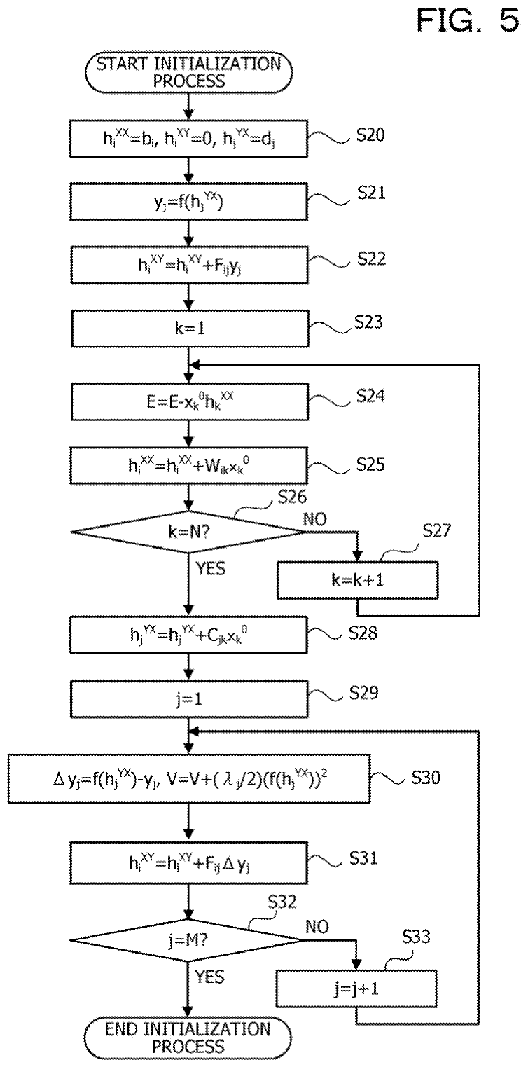

FIG. 5 is a flowchart illustrating a flow of the example of the procedure of the initialization process.

It is assumed that E and V are initialized to 0.

First, the initial value calculation unit 33a sets hⱼ^{YX}=bᵢ, hᵢ^{XY}=0, and hⱼ^{YX}=dⱼ for hⱼ^{YX}, hᵢ^{XY}, and hⱼ^{YX} of every i from 1 to N and every j from 1 to M (step S20). The initial value calculation unit 33a calculates yⱼ of every j from 1 to M by using an expression yⱼ=f(hⱼ^{YX}) (step S21). After the processing of step S21, the initial value calculation unit 33a updates hᵢ^{XY} of every i from 1 to N by using Fᵢⱼyⱼ of every j from 1 to M and an expression hᵢ^{XY}=hᵢ^{XY}+Fᵢⱼyⱼ (step S22).

Then, the initial value calculation unit 33a sets k that is a variable representative of the identification number of the state variable to k=1 (step S23) and updates E by using the following expression: E=E−xₖ⁰hₖ^{XX} (step S24). Furthermore, the initial value calculation unit 33a updates hᵢ^{XX} of every i from 1 to N by using the following expression: hᵢ^{XX}=hⱼ^{YX}=Wᵢₖxₖ⁰ (step S25). Here, xₖ⁰ represents an initial value of the state variable with an identification number=k.

After the processing of step S25, the initial value calculation unit 33a determines whether k=N holds (step S26). In the case where it is determined that k=N does not hold, k=k+1 is set (step S27), and the processing from step S24 is repeated.

In the case where it is determined that k=N holds, by using an expression of hⱼ^{YX}=hⱼ^{YX}+Cⱼₖxₖ⁰, the initial value calculation unit 33a updates hⱼ^{YX} of every j from 1 to M by using Cⱼₖxₖ⁰ of every k from 1 to N (step S28).

Then, the initial value calculation unit 33a sets the variable j indicative of the identification number of the constraint as j=1 (step S29). The initial value calculation unit 33a calculates Δyⱼ by using an expression of Δyₖ=f(hⱼ^{YX})−yⱼ and updates V by using an expression of V=V+(λⱼ/2)(f(hⱼ^{YX}))² (step S30).

Then, the initial value calculation unit 33a updates hᵢ^{XY} of every i from 1 to N by using the following expression: hᵢ^{XY}=hᵢ^{XY}+FᵢⱼΔyⱼ (step S31).

After the processing of step S31, the initial value calculation unit 33a determines whether j=M holds (step S32). In the case where it is determined that j=M does not hold, j=j+1 is set (step S33), and the processing from step S30 is repeated.

In the case where it is determined that j=M holds, the initial value calculation unit 33a ends the initialization process.

Next, an example of the ΔH calculation procedure in step S13 of FIG. 4 is described.

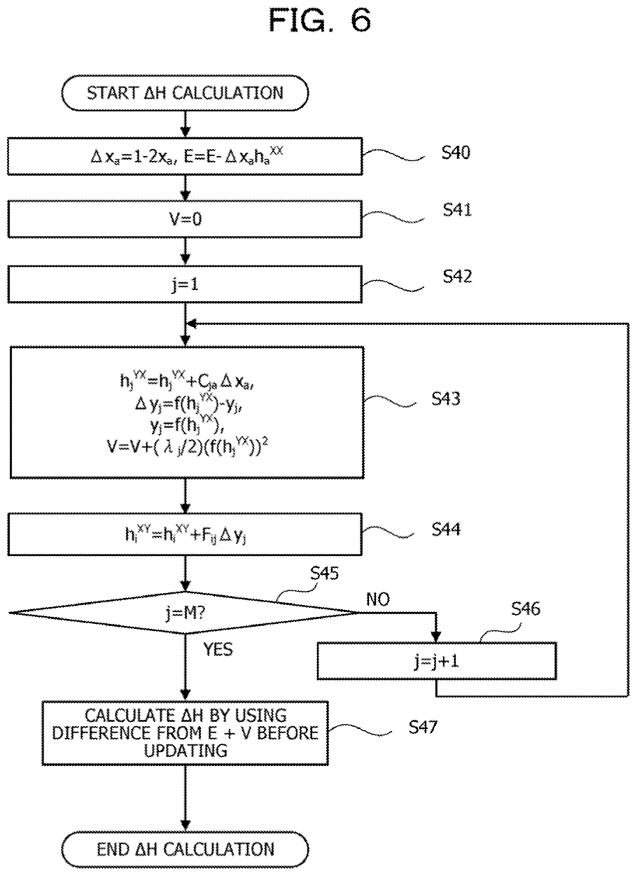

FIG. 6 is a flowchart illustrating a flow of the example of the ΔH calculation procedure. FIG. 6 illustrates an example of the case where Xₐ is selected as the flip candidate state variable.

The Δx calculation unit 33d calculates Δxₐ which is the change amount of the value of xₐ by using an expression of Δxₐ=1−2xₐ. The E updating and holding unit 33e calculates the updated value of E by using an expression of E=E−Δxₐhₐ^{XX} (step S40).

The V updating and holding unit 33f initializes V to set V=0 (step S41). The h&y updating and holding unit 33b and the V updating and holding unit 33f set the variable j indicative of the identification number of the constraint as j=1 (step S42). Then, the h&y updating and holding unit 33b calculates the updated value of hⱼ^{YX} due to the change in the value of xₐ by using an expression of hⱼ^{YX}=hⱼ^{YX}+CⱼₐΔxₐ and calculates Δyⱼ due to the change in the value of xₐ by using an expression of Δyⱼ=f(hⱼ^{YX})−yⱼ. By using hⱼ^{YX} before the updating, yⱼ may be represented as yⱼ=f(hⱼ^{YX}). By using the updated value of hⱼ^{YX}, the V updating and holding unit 33f calculates an updated value of V due to the change in the value of xₐ by using the following expression: V=V+(λⱼ/2)(f(hⱼ^{YX}))² (step S43).

Then, the h&y updating and holding unit 33b calculates the updated value of hᵢ^{XY} of every i from 1 to N due to the change in the value of xₐ by using the following expression: hᵢ^{XY}=hᵢ^{XY}+FᵢⱼΔyⱼ (step S44).

After the processing of step S44, the h&y updating and holding unit 33b and the V updating and holding unit 33f determine whether j=M holds (step S45). In the case where it is determined that j=M does not hold, j=j+1 is set (step S46), and the processing from step S43 is repeated.

In the case where it is determined that j=M holds, the ΔH calculation unit 33g calculates ΔH by calculating the difference between E+V after the updating due to the change in the value of xₐ and E+V before this updating (step S47) and ends the calculation of ΔH.

Since ΔE due to the change in the value of xₐ may be represented as ΔE=−Δxₐhₐ^{XX} and ΔV which is the change amount of V due to the change in the value of xₐ may be represented as ΔV=−Δxₐhₐ^{XY}, the ΔH calculation unit 33g may also calculate ΔH by using the following expression: ΔH=−Δxₐ(hₐ^{XX}+hₐ^{XY}).

The order of the processes illustrated in FIGS. 4 to 6 is merely exemplary and may be changed as appropriate.

With the data processing apparatus 20 and the method of processing data as described above, similar effects to those of the data processing apparatus 10 and the method of processing data according to the first embodiment may be obtained. For example, in the calculation of the updated value of hⱼ^{YX} for calculating ΔH, it is sufficient that M coefficients in a certain column of the matrix C be read in the processing of step S43. Thus, the amount of calculation may be decreased compared to the case where the flip determination for a certain state variable is performed by using all the elements of the matrix C. Furthermore, the amount of data read at a time from the storage unit 32 may be decreased.

In the processing of step S44, when the number of auxiliary variables (yⱼ) the values of which change due to the change in the value of xₐ is p, the number of coefficients read from the matrix F for updating hᵢ^{XY} may be Np. Accordingly, the number of coefficients read from the matrix C and the matrix F for updating the local fields due to the change in the value of xₐ is M+Np.

As has been described, the processing content described above may be realized by causing the data processing apparatus 20 to execute a program.

The program may be recorded in a computer-readable recording medium (for example, the recording medium 26a). As the recording medium, for example, a magnetic disk, an optical disk, a magneto-optical disk, a semiconductor memory, or the like may be used. Examples of the magnetic disk include an FD and an HDD. Examples of the optical disk include a CD, a CD-recordable (R)/rewritable (RW), a DVD, and a DVD-R/RW. The program may be recorded in a portable-type recording medium to be distributed. In this case, the program may be copied from the portable-type recording medium to another recording medium (for example, the HDD 23) to be executed.

### Third Embodiment

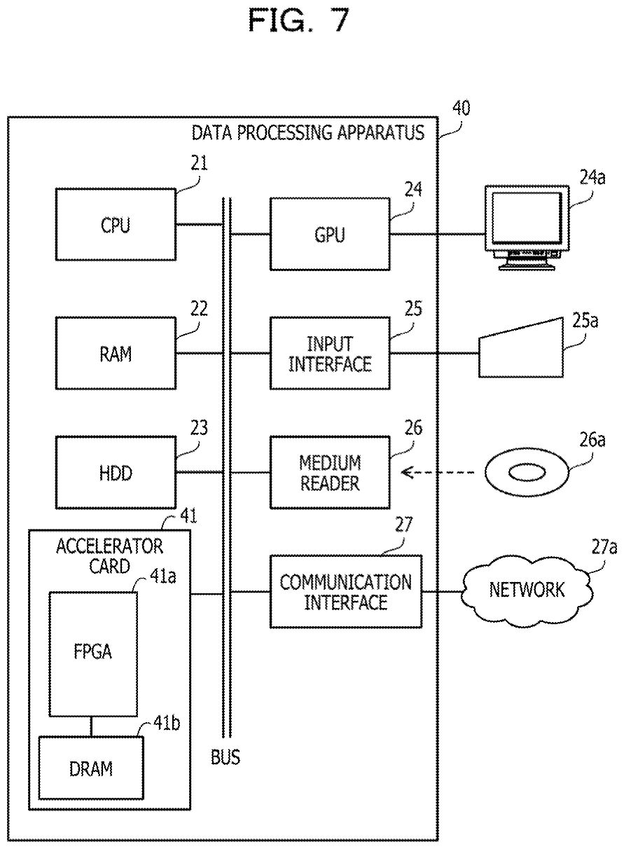

FIG. 7 illustrates an example of a data processing apparatus according to a third embodiment. In FIG. 7, the same elements as the elements illustrated in FIG. 2 are denoted by the same reference signs.

A data processing apparatus 40 according to the third embodiment includes an accelerator card 41 coupled to the bus.

The accelerator card 41 is a hardware accelerator that searches for a solution to a discrete optimization problem. The accelerator card 41 includes an FPGA 41a and a DRAM 41b.

In the data processing apparatus 40 according to the third embodiment, the FPGA 41a performs, for example, the processes by the control unit 31 and the search unit 33 illustrated in FIG. 3.

The DRAM 41b functions as the storage unit 32 illustrated in FIG. 3.

A plurality of accelerator cards 41 may be provided. In this case, for example, the processing (for example, the processing of steps S12 to S16 illustrated in FIG. 4) for the replicas may be performed in parallel.

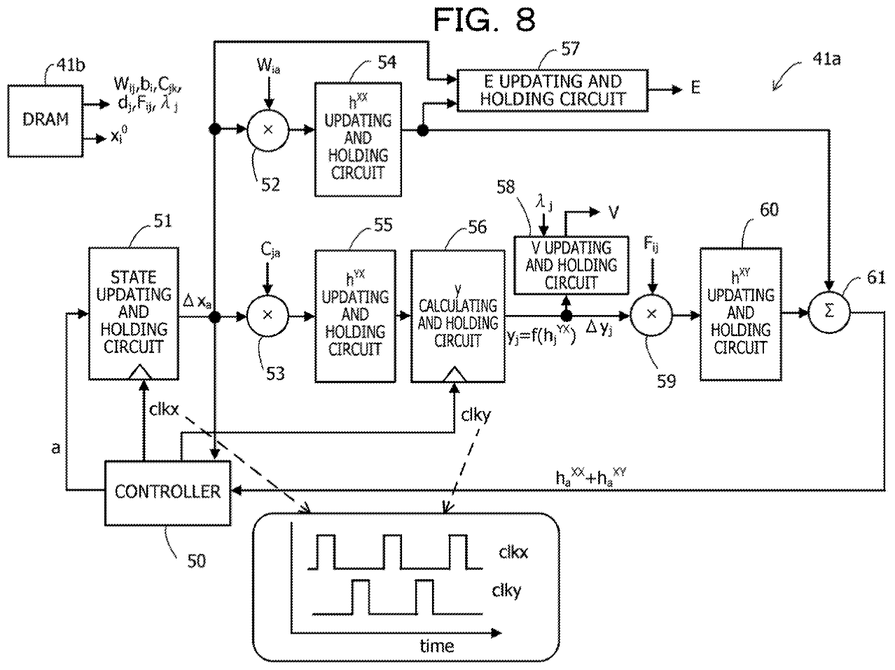

FIG. 8 is a diagram illustrating an example of the configuration of the FPGA.

The FPGA 41a includes a controller 50, a state updating and holding circuit 51, multipliers 52 and 53, an h^{XX} updating and holding circuit 54, an h^{YX} updating and holding circuit 55, a y calculating and holding circuit 56, an E updating and holding circuit 57, a V updating and holding circuit 58, a multiplier 59, an h^{XY} updating and holding circuit 60, and an addition circuit 61.

The controller 50 controls portions of the FPGA 41a. For example, as illustrated in FIG. 8, the controller 50 generates and outputs clock signals (clkx, clky) for determining operation timing of the state updating and holding circuit 51 and the y calculating and holding circuit 56.

The controller 50 has the function of selecting the flip candidate state variable and the function of determining whether to allow the change in the value of the flip candidate state variable based on an addition result of two types of local fields output by the addition circuit 61. For example, in the case where xₐ is selected as the flip candidate state variable, the controller 50 outputs the identification number=a. Based on hₐ^{XX}+hₐ^{XY} which is the addition result output by the addition circuit 61 and Δxₐ output by the state updating and holding circuit 51, the controller 50 calculates ΔH=−Δxₐ(hₐ^{XX}+hₐ^{XY}). The controller 50 determines whether to allow the change in the value of xₐ based on a result of comparison between ΔH and a noise value obtained based on a random number and the value of the temperature parameter.

The state updating and holding circuit 51 includes, for example, a register, a static random-access memory (SRAM), or the like and holds values of N state variables xᵢ (i=1 to N). An initial value xᵢ⁰ of N state variables xᵢ is read from the DRAM 41b and held in the state updating and holding circuit 51.

The state updating and holding circuit 51 outputs the change amount in the case where the value of the flip candidate state variable designated by the controller 50 is changed. For example, in the case where a is designated as the identification number of the state variable, the state updating and holding circuit 51 outputs Δxₐ which is the change amount of xₐ.

In the case where the state updating and holding circuit 51 receives, from the controller 50, a signal indicative of allowing the change in the value of the flip candidate state variable, the state updating and holding circuit 51 updates the state by changing the value of the state variable from 0 to 1 or from 1 to 0.

The multiplier 52 outputs the products of the change amount of the state variable and the weight values in a row or a column related to the flip candidate state variable out of a matrix W of N×N weight values Wᵢⱼ stored in the DRAM 41b. For example, in the case where the flip candidate state variable is xₐ, N weight values (Wᵢₐ) in an a column out of the matrix W are read from the DRAM 41b, and the products of Δxₐ and Wᵢₐ are output.

The multiplier 53 outputs the products of the change amount of the state variable and the coefficients in a column related to the flip candidate state variable out of the matrix C of M×N coefficients Cⱼₖ stored in the DRAM 41b. For example, in the case where the flip candidate state variable is xₐ, M coefficients (Cⱼₐ) in an a column out of the matrix C are read from the DRAM 41b, and the products of Δxₐ and Cⱼₐ are output.

The h^{XX} updating and holding circuit 54 includes, for example, a register, an SRAM, or the like, holds N local fields hᵢ^{XX}, and calculates updated values of N local fields hᵢ^{XX} by adding each of N products output by the multiplier 52 to corresponding hᵢ^{XX} out of N local fields hᵢ^{XX}. An initial value bᵢ of N local fields hᵢ^{XX} is read from the DRAM 41b and held in the h^{XX} updating and holding circuit 54.

The h^{YX} updating and holding circuit 55 includes, for example, a register, an SRAM, or the like, holds M local fields hⱼ^{YX}, and calculates updated values of M local fields hⱼ^{YX} by adding each of M products output by the multiplier 53 to corresponding hⱼ^{YX} out of M local fields hᵢ^{YX}. An initial value of M local fields hⱼ^{YX} is read from the DRAM 41b and held in the h^{YX} updating and holding circuit 55.

The y calculating and holding circuit 56 calculates yⱼ which is M auxiliary variables and a difference (Δyⱼ) from the previously calculated yⱼ. In the case where yⱼ is an auxiliary variable related to the inequality constraint, it may be represented as yⱼ=f(hⱼ^{YX})=max[0, hᵢ^{YX}] as described above. In the case where yⱼ is an auxiliary variable related to the equality constraint, it may be represented as yⱼ=f(hⱼ^{YX})=(hⱼ^{YX})² as described above. In the case where yⱼ is an auxiliary variable related to the absolute value constraint, it may be represented as yⱼ=f(hᵢ^{YX})=abs(hⱼ^{YX}) as described above.

Although the y calculating and holding circuit 56 may be a circuit that performs calculation of f(hⱼ^{YX}) corresponding to any of the above plurality of constraint conditions, the y calculating and holding circuit 56 may be a circuit that performs calculation of f(hᵢ^{YX}) corresponding to each of the above plurality of constraint conditions. For example, the y calculating and holding circuit 56 may include three types of circuits that respectively calculate the three types of f(hⱼ^{YX}) described above, and the circuit to be used may be switched under the control of the controller 50.

For example, the y calculating and holding circuit 56 includes a register, an SRAM, or the like and holds M auxiliary variables yⱼ having been calculated.

For example, the E updating and holding circuit 57 includes a register, an SRAM, or the like, holds E that is the value of the evaluation function indicated in Expression (1), and calculates the updated value of E. For example, in the case where the change in the value of xₐ is allowed, the updated value of E is obtained by using the following expression: E=E−Δxₐhₐ^{XX}. As an initial value of E, 0 is set in the E updating and holding circuit 57.

For example, the V updating and holding circuit 58 includes a register, an SRAM, or the like, holds V that is the entire magnitude of M constraint terms indicated in Expression (7), and calculates the updated value of V. As an initial value of V, 0 is set in the V updating and holding circuit 58.

The multiplier 59 outputs the product of Δyⱼ and Fᵢⱼ read from the DRAM 41b.

The h^{XY} updating and holding circuit 60 includes, for example, a register, an SRAM, or the like, holds N local fields hᵢ^{XY}, and calculates the updated values of N local fields hᵢ^{XY} by adding FᵢⱼΔyⱼ, for each j, output by the multiplier 59 to corresponding hᵢ^{XY} out of N local fields hᵢ^{XY}. As an initial value of N local fields hᵢ^{XY}, 0 is set in the h^{XY} updating and holding circuit 60.

The addition circuit 61 outputs the addition result of the local field held in the h^{XY} updating and holding circuit 60 and the local field held by the h^{XX} updating and holding circuit 54. This addition result is used by the controller 50 for the calculation of ΔH. In the case where the value of xₐ changes, the addition circuit 61 outputs hₐ^{XX}+hₐ^{XY} as illustrated in FIG. 8.

The controller 50 may calculate ΔE from E before and after the updating output by the E updating and holding circuit 57 and ΔV from V before and after the updating output by the V updating and holding circuit 58 so as to calculate ΔH=ΔE+ΔV. The controller 50 may calculate H=E+V from E before the updating output by the E updating and holding circuit 57 and V before the updating output by the V updating and holding circuit 58 so as to calculate ΔH from the difference between E+V before the updating and the sum of E and V after the updating. In these cases, the multiplier 59, the h^{XY} updating and holding circuit 60, and the addition circuit 61 may be omitted.

Also with the data processing apparatus 40 according to the third embodiment as described above, the effects similar to those of the data processing apparatus 20 according to the second embodiment are obtained.

Although aspects of the data processing apparatus, the program, and the method of processing data according to the present disclosure have been described above based on the embodiments, the embodiments are merely exemplary and not limited to the above description.

For example, a spin variable (sᵢ) having a value of −1 or 1 may be used as the state variable. In this case, the above-described state variable (xᵢ) may be set to xᵢ=(sᵢ+1)/2.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data processing apparatus of searching for a combination of values of a plurality of state variables with which a value of an evaluation function of an Ising-type becomes a local minimum or a local maximum, the data processing apparatus comprising:
a memory configured to store a plurality of first local fields representative of a plurality of first change amounts of the value of the evaluation function in a case where a value of each of the plurality of state variables changes, a plurality of first coefficients indicative of strength of influence of each of the plurality of state variables on each of a plurality of constraint terms representative of a constraint condition, and a plurality of second local fields represented by a sum of a total sum of products of each of the plurality of first coefficients and each of the plurality of state variables and a second coefficient related to the constraint condition; and
a processor coupled to the memory, the processor being configured to perform processing including:
reading, from the memory, a first coefficient, out of the plurality of first coefficients, related to a first state variable which is any of the plurality of state variables;
calculating updated values of the plurality of second local fields in a case where a value of the first state variable changes based on the first coefficient;
calculating, in the case where the value of the first state variable changes, a second change amount of a sum of the evaluation function and an entire magnitude of the plurality of constraint terms based on the updated values and a first local field, out of the plurality of first local fields, related to the first state variable; and
determining whether to allow a change in the value of the first state variable based on a result of comparison between the second change amount and a predetermined value.

2. The data processing apparatus according to claim 1, wherein,
in a case where it is determined that the change in the value of the first state variable is allowed, the processing unit changes the value of the first state variable and performs an updating process in which the plurality of first local fields and the plurality of second local fields are updated.

3. The data processing apparatus according to claim 2, wherein,
the processor is configured to search for the combination of the values of the plurality of state variables with which the value of the evaluation function becomes the local minimum or the local maximum by performing, for each of the plurality of state variables, processing of the reading of the first coefficient, the calculating of the updated values, the calculating of the second change amount, and the determining of whether to allow the change in the value of the first state variable and by performing the updating process.

4. The data processing apparatus according to claim 1, wherein
a plurality of third coefficients indicate strength of influence of each of the plurality of constraint terms on the first state variable, wherein
the processor is configured to:
calculate a third local field that is a total sum of products of each of the plurality of constraint terms calculated by using the updated values of the plurality of second local fields in a case where the first state variable changes and each of the plurality of third coefficients; and
calculate the second change amount by using a product of the change amount of the first state variable and a sum of the first local field and the third local field.

5. The data processing apparatus according to claim 1, wherein,
the constraint condition is an inequality constraint, an equality constraint, or an absolute value constraint.

6. A non-transitory computer-readable recording medium storing a program of searching for a combination of values of a plurality of state variables with which a value of an evaluation function of an Ising-type which includes the plurality of state variables becomes a local minimum or a local maximum, the program including instructions which, when the program is executed by a computer, cause the computer to execute processing including:
reading a first coefficient, out of a plurality of first coefficients, related to a first state variable which is any of a plurality of state variables from a storage unit that stores a plurality of first local fields representative of a plurality of first change amounts of the value of the evaluation function in a case where a value of each of the plurality of state variables changes, the plurality of first coefficients indicative of strength of influence of each of the plurality of state variables on each of a plurality of constraint terms representative of a constraint condition, and a plurality of second local fields represented by a sum of a total sum of products of each of the plurality of first coefficients and each of the plurality of state variables and a second coefficient related to the constraint condition;
calculating updated values of the plurality of second local fields in the case where a value of the first state variable changes based on the first coefficient;
calculating, in the case where the value of the first state variable changes, a second change amount of a sum of the evaluation function and an entire magnitude of the plurality of constraint terms based on the updated values and a first local field, out of the plurality of first local fields, related to the first state variable; and
determining whether to allow a change in the value of the first state variable based on a result of comparison between the second change amount and a predetermined value.

7. A computer-implemented method of searching for a combination of values of a plurality of state variables with which a value of an evaluation function of an Ising-type which includes the plurality of state variables becomes a local minimum or a local maximum, the method comprising:
reading a first coefficient, out of a plurality of first coefficients, related to a first state variable which is any of a plurality of state variables from a storage unit that stores a plurality of first local fields representative of a plurality of first change amounts of the value of the evaluation function in a case where a value of each of the plurality of state variables changes, the plurality of first coefficients indicative of strength of influence of each of the plurality of state variables on each of a plurality of constraint terms representative of a constraint condition, and a plurality of second local fields represented by a sum of a total sum of products of each of the plurality of first coefficients and each of the plurality of state variables and a second coefficient related to the constraint condition;
calculating updated values of the plurality of second local fields in the case where a value of the first state variable changes based on the first coefficient;
calculating, in the case where the value of the first state variable changes, a second change amount of a sum of the evaluation function and an entire magnitude of the plurality of constraint terms based on the updated values and a first local field, out of the plurality of first local fields, related to the first state variable; and
determining whether to allow a change in the value of the first state variable based on a result of comparison between the second change amount and a predetermined value.
